(19) United States
(12) Patent Application Publication
(10) Pub. No.: US 2020/0236162 A1
(43) Pub. Date: Jul. 23, 2020

(54) NETWORK OF INTELLIGENT NODES FOR MESH DISTRIBUTED NETWORK ADAPTABLE TO INDUSTRIAL OR SERVICE APPLICATIONS

(71) Applicant: Atos Worldgrid, Bezons (FR)

(72) Inventors: Lionel BOUZON, St Pierre d'Allevard (FR); Lionel DEBROUX, St Etienne de Sainte Geoirs (FR); Charles EYNARD, Grenoble (FR); Christophe VOISIN, Le Sappey en Chartreuse (FR); Vincent DIMITRIOU, Champ-sur-Drac (FR); Emmanuel ZYCHLA, Montbonnet (FR)

(21) Appl. No.: 16/722,037

(22) Filed: Dec. 20, 2019

(30) Foreign Application Priority Data
Dec. 20, 2018 (FR) 1873678

(51) Int. Cl. H04L 29/08

(52) U.S. Cl. CPC H04L 67/104

(57) ABSTRACT

The present invention relates to a network of smart Nodes for a mesh distributed network adaptable to industrial applications, each node allowing, by means of GCOM communication middleware, peer-to-peer bidirectional communication with other nodes or with a central Big Data Management platform allowing the acquisition, management and storage of a data lake or with a public or private cloud, each node comprising a computer hardware architecture, said architecture running under an operating system and a software stack using an object-oriented language, the network being characterized in that one or more nodes are deployed at different aggregation levels including at least one off the plant site, at least one close to the plant's process automatons, at least one in the control room and at least one per cloud, the execution of said software stack on the computer hardware architecture implements a set of functionalities, internal communication within the mesh and external communication with other systems being message-oriented.

### CROSS-REFERENCE TO RELATED APPLICATIONS

This application claims the benefit of French Patent Application No. 1873678 filed Dec. 20, 2018, the disclosure of which is herein incorporated by reference in its entirety.

### TECHNICAL FIELD OF THE INVENTION

The present invention relates to the field of conducting industrial or service processes in a secure, completely distributed environment.

### PRIOR ART

Nowadays, data transit very intensely, mainly in fields such as machine learning where it is considered to be the raw material.

Thus it is very beneficial and even vital to share one's data in order to expose it to the best learning techniques. However, this sharing is a risk factor. Indeed, several questions are raised by this sharing, including security and scalability. Therefore, how to exchange data on an industrial process and exchange data on derived products resulting from the initial data (Machine Learning model, personal data enrichment, etc.).

A solution known from conventional industrial supervision systems is SCADA, which for its part, is architectured solely to retrieve industrial data without deploying intelligence at the network edge. In a conventional supervision system (SCADA), the devices (RTUs) are configured statically and their primary function is to display data. In addition, pre-existing markings are not transmitted to the derived result such as data transformations, model constructs, resulting from already shared data. In other words, marking stops after the data is shared and is not broadcast to the products derived from this data. It is therefore not transitive or hereditary.

Thus, the document: GOOSE S ET AL “SKYDA: Cloud-based, secure SCADA-as-a-service”, INTERNATIONAL TRANSACTIONS ON ELECTRICAL ENERGY SYSTEMS, vol. 25, no. 11, November 2015 (2015-011), pages 3004-3016, XP009192722, ISSN:2050-7038, DOI: doi:10.1002/etep.2018, hereinafter referred to as D1, is prior art of this type.

Although D1 discloses a SCADA-type supervision system, this system is limited to the safe management of intelligent electrical networks (smart grids) and is not usable for all processes.

Indeed, the architecture (SKYDA), of the SCADA supervision system, described in D1, duplicates elements (“master application”) of the SCADA system in “clouds” in order to secure the supervision processes. No mention is made at any time of the features or functionalities of the SCADA supervision system in the management of industrial processes or, for example, of a stored list of neighborhoods used by smart nodes in the execution of industrial processes. Furthermore, D1 does not teach that the architecture (SKYDA), as described, can work without using at least two Clouds. The system disclosed in D1 remains a central infrastructure (master to slave RTU (Remote Terminal Unit)) with localization of the master(s) in one or more Clouds.

### DISCLOSURE OF THE INVENTION

The present invention has the aim of overcoming certain drawbacks of the prior art of systems for monitoring and controlling industrial or service processes and in particular of facilitating data sharing in a decentralized environment, offering the possibility, for the owner who shares their data, to obtain derived products that result from the exploitation of their data to enrich and improve the control and management thereof while retaining flexibility to adapt to new sites while ensuring security.

For this purpose, the present invention relates to a network of smart nodes for a mesh distributed network adaptable to industrial applications, each node allowing, by means of GCOM communication middleware, peer-to-peer bidirectional communication with other nodes or with a central Big Data Management platform allowing the acquisition, management and storage of a data lake or with a public or private cloud, each node comprising a computer hardware architecture, said architecture running under an operating system and a software stack using an object-oriented language, the network being characterized in that one or more nodes are deployed at different aggregation levels including at least one off the plant site, at least one close to the plant's process automatons, at least one in the control room and at least one per cloud, the execution of said software stack on the computer hardware architecture implements a set of functionalities, internal communication within the mesh and external communication with other systems being message-oriented.

According to another special feature, internal communication within the mesh of CIS nodes and external communication with other systems is based on a message-oriented architecture containing either data or logic elements.

According to another special feature, the logic elements can be specified individually through the creation of services whose definition is transmitted to the software of each smart node (CIS Smart Nodes) by messages and by using the OPSY module for managing deployments and the REPOSI module for managing software repositories as well as the CNFG module for managing the configuration.

According to another special feature, each node of the network has several functional subsystems suitable for aggregating the node in the network.

According to another special feature, the functional subsystems are selected for all the nodes among the following modules:
CNFG for managing the configuration of each smart node;
OPSY for managing software deployments (e.g. for security patches, upgrades and application maintenance);
REPOSI for managing software repositories;
ITOP for managing interoperability with third-party systems;
GCOM for managing communication within the mesh (middleware);
USRM for managing users and permissions.

According to another special feature, the functional subsystems of a node placed in the neighborhood of the process automatons of a plant comprise: the LSVC subsystem for the functionality of managing drivers and technical services for industrial instrumentation.

According to another special feature, the GUIF functional subsystems of a node deployed from the central platform makes it possible to produce web visualization modules local to a given workshop of the process defined by the node close to the workshop identified in the message.

According to another special feature, the functional subsystems of at least one intermediate node between the node neighboring the automatons and the node neighboring the cloud comprise the module is made up of HSVC for managing pre-processing and local calculations on the plant results or data.

According to another special feature, the functional subsystems of at least one node exchanging with nodes in other countries comprise the UTLY module for managing utilities such as for example multilingual management.

According to another special feature, the network comprises at least one of the following functionalities:
creation and management, for itself or the other nodes of the mesh, of objects adapted to industrial processes in order to supervise and control all types of processes, the group of objects defined for the entire mesh and known by each node being referred to as “object dictionary”;
deployment of a plurality of nodes in a distributed mesh by the neighborhood effect;
start-up and communication of each node via the communication module in its immediate neighborhood thanks to a plant configuration with a minimal range of functionalities;
memorization and management of at least one object by each node to maintain the current status of the object and using a stored list of neighborhoods of the nodes to which it is itself connected, in order to inform each neighboring node of any change in the status of the object;
association, with the communication module of each node, of a node-specific identifier and a neighborhood identifier, in order to make each node iso-functional and capable of receiving an execution order coming from a program of another node of the mesh.

According to another special feature, the systematic broadcast of data or commands is done by configuring the broadcast module of the node [Smart Node], this broadcast module being initially configured to implement, by execution on the computer hardware architecture, a functionality for broadcasting, within the network (8), a variable or a given group of variables with a given resolution and up to a given depth in the mesh, for example 3 or 4 neighborhood levels.

According to another special feature, the network comprises a node management module that manages the functionalities implemented by the software modules, executed on the computer hardware architecture, by monitoring and controlling the restarting and security updates of a software module that would fail or die.

According to another special feature, each object belongs to at least one class which is a description of the features of one or more objects representative of an industrial process or a business feature, each object being created from this class and constituting an instance of the class in question, the features and the status of an object being manipulated by methods incorporated in the smart node, the status of an object corresponding to the information stored at a given time, as described by the values of all its properties, also called fields or attributes.

According to another special feature, each node comprises at least one software layer, said software layer implementing, by execution on the computer hardware architecture, a functionality for memorizing, in addition to the information coming from the process sensors, an attribute indicating that the node concerned is a parent of the object referred to as “parent node”.

According to another special feature, each node comprises a device comprising at least one software layer, said software layer implementing, by execution on the computer hardware architecture, a functionality for informing each node of its neighborhood so that the neighbor nodes inform the other nodes following a path oriented in a direction which depends on the specific topology or architecture of the mesh, defining the links between the nodes of the network, and if necessary following a path oriented towards a central platform or towards the processes, each node thus informing the rest of the mesh and each node thus storing the object, its current status and the parent node to which the object is assigned.

According to another special feature, said functionalities implemented by the node also comprise broadcasting, in the form of time series, the data collected or calculated by each node, said broadcast being carried out by using at least one of the following two data broadcast modes: a so-called systematic broadcast mode wherein the data are broadcast with a given resolution and up to a given depth in the mesh, and a so-called opportunistic broadcast mode wherein at least one node neighboring another node concerned by a given initial request, autonomously records the information or data which passes through it in its memory in order to rebroadcast said data or information when a request similar to the initial request is made again, the pattern or scheme for broadcasting data broadcast by the nodes differing from a systematic replication scheme wherein the data broadcast scheme is duplicated identically for all the nodes.

According to another special feature, each node is configured to implement a planned functionality for the systematic historization of data, but also the storage of the actions that take place periodically or actions relating to the so-called opportunistic broadcast mode in its memory, each node thus having the ability to behave autonomously for the historization of the data collected during actions that take place periodically or actions relating to the so-called opportunistic broadcast mode.

According to another special feature, each node of the mesh or a central platform comprises a device comprising at least one software layer, said software layer implementing, by execution on the computer hardware architecture, the functionalities for creating and managing, for itself or the other nodes of the mesh, objects adapted to industrial processes so as to control all types of processes, the set of objects defined for the entire mesh and known to each of the nodes being referred to as “object dictionary”.

According to another special feature, each node has at least one interface for accessing an image of the “object dictionary”, this interface being configured to define a new node or a new object for a node, the modification request being broadcast in the mesh and transmitted from one node to another to the concerned parent node if the modification made to the dictionary does not concern the node from which the manager is accessed, the parent node of the object then executing the request, the result of the execution then being broadcast in turn to the rest of the mesh, each node receiving this result then updating its own image of the “object dictionary”.

According to another special feature, said functionalities implemented by each smart node comprise rebroadcasting, via its broadcast module, to the rest of the mesh and at configurable time intervals the status of its own objects, in order to compensate for any temporary or persistent communication breakdown in the mesh, this ability enabling the mesh to restore, if necessary, the integrity of the various images, associated with the various nodes of the mesh, of the “object dictionary”.

According to another special feature, the objects are manipulated without the modifications made to the status of one object calling upon or influencing the status of another object, each object having access authorization for any use or any entity in the industrial process, with the attributes or definition fields of the objects being changed dynamically by the node manager.

According to another special feature, each object uses a method that defines a quality parameter associated with same, said quality parameter representing the deviation between a desired target value of the status of an object and the actual status of the value.

According to another special feature, each node of the mesh or the central platform (10) comprises a device including at least one software layer, said software layer implementing, by execution on a computer hardware architecture, a functionality for connecting to any node of the mesh, by sending the identifier of the node to be modified, so as to remotely and dynamically modify the node concerned even if the user is connected to a node that is not the parent node of the object to be modified.

Other features and advantages of the present invention are detailed in the following description.

### BRIEF DESCRIPTION OF THE FIGURES

Other special features and advantages of the present invention will become clear from reading the following description, made in reference to the appended drawings, wherein:

FIG. 1 schematically represents a typical deployment of a scalable infrastructure of a network of smart nodes for the control of industrial or service processes connected to one or more clouds;

FIG. 2 schematically represents the hardware architecture 200 of a smart node;

FIG. 3 schematically represents the software stacks that can be installed on the nodes;

FIG. 4 represents the modularization of each software subsystem.

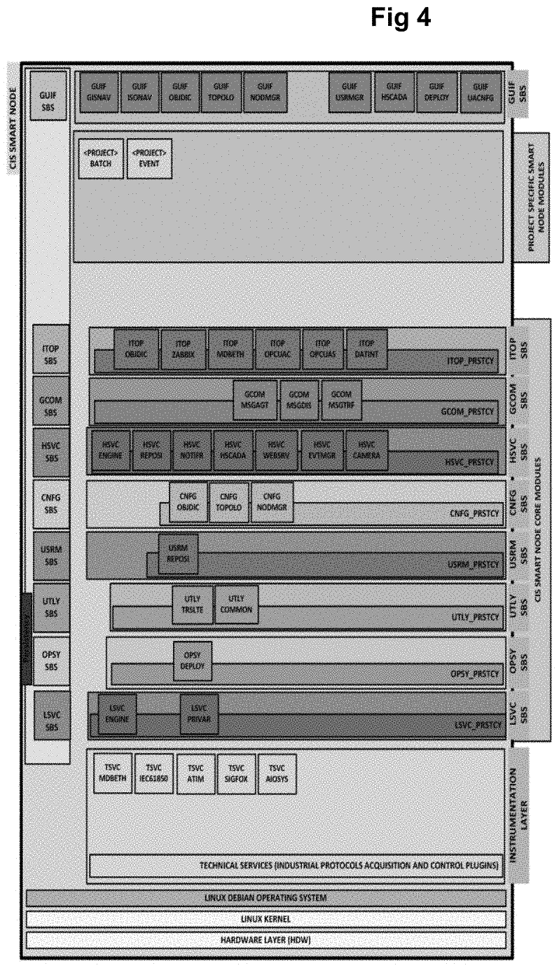

### DESCRIPTION OF THE EMBODIMENTS

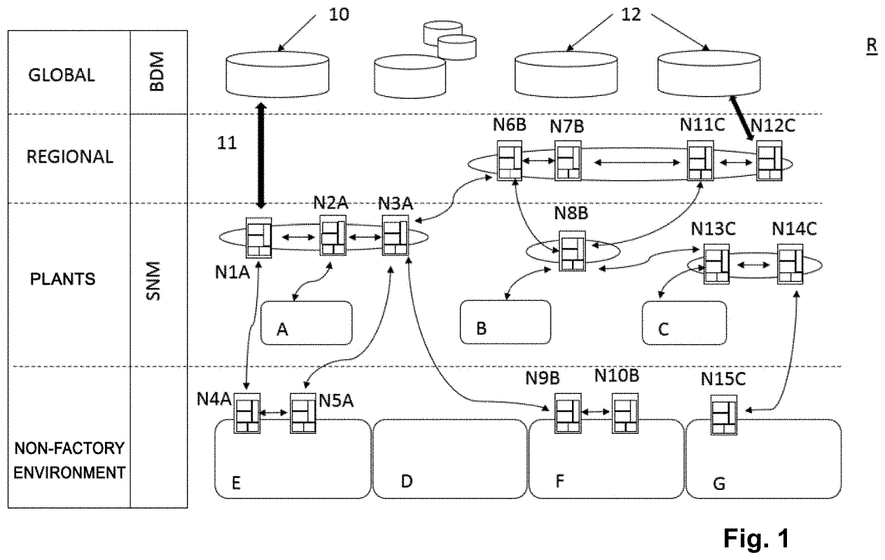

FIG. 1 depicts a typical deployment of a scalable network infrastructure of smart nodes (SN) in the context of an industrial application. The Smart Nodes (SN) are thus deployed on one or more sites (A, B, C), on different processing workshops or even on third-party infrastructures (E, D, F, G) allowing data collection (territory, weather, wireless sensor back-ends).

The present invention relates to a network made up of smart nodes (N, FIG. 1) in order to constitute a network (R) distributed according to a scalable mesh for the management and monitoring of one or more industrial or service processes as shown in FIG. 1. This edge computing infrastructure is based on a mesh of software nodes called Smart Nodes. Edge computing is the ability for a software infrastructure to know how to deploy, manage and execute software modules with high added value (calculations, optimization, operating assistance) at the network edge (Edge) and in particular at the level of the operational networks, thus as close as possible to industrial processes. Edge computing capabilities thus differ from conventional industrial supervision systems, which for their part, are only architectured to feed back industrial data without deploying intelligence at the network edge. In a conventional supervision system (SCADA), the devices (RTUs) are configured statically and their primary function is to display data.

In the example of the figure, an industrial site A sends the data from its processes or sensors to a node (N2A) which has as its neighborhood the node (N1A) in bidirectional communication with a platform (10) and with a node (N3A) that communicates with a node (N8B). The node (N1A) also communicates with the nodes (N4A and N5A) collecting data coming from external sensors or third-party infrastructures. The node N8B communicates with the site B and with a platform of nodes (N6B, N7B, N11C, N12C) communicating with one another and with a cloud 12.

The Node (N13C) communicates with the instruments or the sensors or the automatons of site C and via the node (N14C) with a node (N15C) collecting other data coming from external sensors or third-party infrastructures.

Finally, the nodes (N9B, N10B) are connected to the sensors or cameras of a non-factory environment required in the application. The Node (N9B) has the node (N10B and N3A) as its network neighborhood. The node (N7B) has the node (N3A, N13C, N12C and N6B) as its network neighborhood

The node mesh is bidirectionally connected to the Smart and Big Data platform (10). This mesh provides the platform with an M2M part for field communications (data acquisition and sending down instructions) but also an infrastructure for locally distributed processing and services (Edge) (pre-processing, industrial supervision calculations, prediction or operating assistance algorithms, graphical interfaces intended for mobile operators).

Thus, the network allows the added value resulting from the data analysis (optimized setpoints, indicators, forecasts, external data, trained models) to be sent down to Smart Node N1A, N7B and N13C from the Central BDM (via the Smart Node N12C).

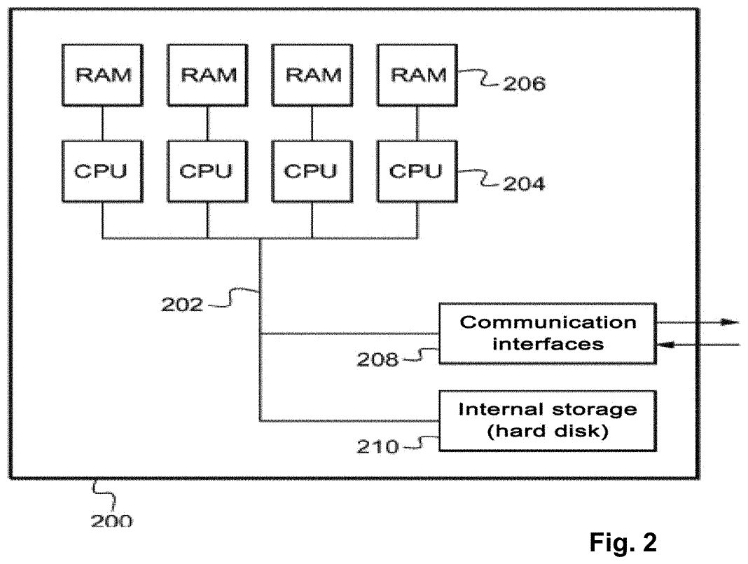

As shown in FIG. 2, each node typically includes one or more microprocessors, local memories and a communication interface. More specifically, the device 200 here comprises a communication bus 202 to which are connected:
CPUs or microprocessors 204;
a random access memory (RAM) component 206, comprising registers suitable for storing variables and parameters created and modified during program execution (as indicated, each RAM component can be associated with a microprocessor); and
communication interfaces 208 suitable for sending and receiving data.

The node 200 here further comprises internal storage means 212, such as hard disks, which are capable in particular of containing the executable program code.

The communication bus allows bidirectional communication and interoperability between the various elements included in the device 200 or connected to same. The microprocessors 204 control and direct the execution of instructions or portions of software code of the program or programs. When the power is turned on, the one or more programs stored in non-volatile memory, such as a hard disk, are transferred to the RAM 206.

The smart nodes (through their software contributions) are deployed between data acquisition and the one or more smart and big data platforms at different aggregation levels (non-factory, near process automatons, in the control room, in a public or private cloud), and therefore in different network neighborhoods.

Bidirectional and peer-to-peer communication between neighborhoods is implemented via the GCOM communication middleware of each smart Node. The whole constitutes a mesh. This is known as SNM (Smart Node Mesh). The SNM is therefore in charge of feeding the analysis part of the Big Data Management (BDM) data in order to enhance the data and then of sending down and serving as close as possible to the process the result and the services resulting from the enhancement of the data at the central level.

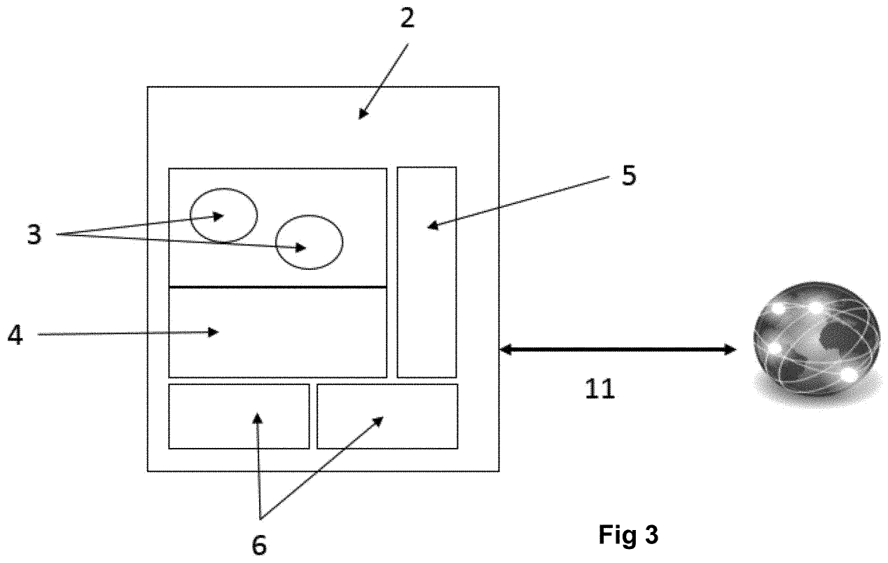

In some embodiments, each smart node incorporates a software stack (2, 3, 4, 5, 6, FIG. 3) with a small footprint (10 to 800 Mbytes, for example from 300 Mbytes to 600 Mbytes for industrial supervision and graphic rendering layers), with low resource consumption and this stack can be executed, for example on a X86 or ARM Raspberry or MIPS type hardened hardware architecture (not shown), with low energy consumption and resistant to harsh environmental conditions (shock and vibration, temperature from −40 to +80° C.) running under a LINUX operating system or similar.

Layer 2 consists of a human-machine interface that can include a GUIF subsystem that can be present on all the nodes or according to the user's choice on a limited number of nodes.

Layer 5 consists of the GCOM communication middleware of the table in FIG. 3.

Layer 6 consists of the LSVC software subsystem for managing drivers and technical services for industrial instrumentation. This layer is necessary for the end node in connection with the industrial sites or the external sensors.

Layers 3 and 4 consist of those defined in the table of FIG. 3 and which have not yet been mentioned above; namely OPSY, UTLY, REPOSI, CNFG, USRM, HSVC.

A smart node conforms to a microservice architecture. It is built around a backbone the Node Manager which is programmed to dynamically activate on demand a range of functionalities from the following categories:
Acquisition and instrumentation capabilities (example: in Modbus, or Physical Signals) by the LSVC subsystem.
Data and message historization, formatting and decentralized calculations on the data
Web-based dashboards for mobile operators
Gateway and Machine To Machine (M2M) Interoperability (via the ITOP subsystem) whether internal, external or third party.

The CIS Smart Node software executed on each smart node is based on a modular design and each node, depending on its location in the mesh is equipped with the necessary modules:

The modules are divided into different functional subsystems (acronym SBS).

The table below lists the different functional subsystems of the CIS Smart Node software:

TABLE 1

| Name | Definition | Functionality |
|---|---|---|
| LSVC | (Low Level Service Subsystem) | Management of drivers and |
| | Low level service subsystem | technical services for |
| | | industrial instrumentation |
| | | (e.g. Modbus) |
| OPSY | (Operating System Subsystem) | Management of software |
| | Operating system subsystem | deployments (security |
| | | patches, updates and |
| | | application maintenance) |
| UTLY | (Utility Subsystem) | Utility management (e.g. |
| | Utility subsystem | multilingual management) |
| REPOSI | (Repository Subsystem) | Software repository |
| | Repository subsystem | management |
| CNFG | (Configuration Subsystem) | Smart Node configuration |
| | Configuration subsystem | management |
| HSVC | (High Level Service Subsystem) | Management of local |
| | High level service subsystem | preprocessing and |
| | | calculations |
| GCOM | (Grid Communication | Management of |
| | Subsystem) | communication within |
| | Grid communication subsystem | the mesh (CIS Middleware) |
| ITOP | (Interoperability Subsystem) | Management of |
| | Interoperability subsystem | interoperability with third- |
| | | party and external systems |

Each subsystem can host several modules.

Each module covers a specific functionality within the Smart Node. A given functionality can be generic or specific to a business area/project, for example in relation to a field of industrial application.

FIG. 5 shows all the functional modules that make up a CIS Smart Node software.

Internal communication within the mesh of CIS nodes and external communication with other systems (e.g. IoT Platform) is based on a message-oriented architecture containing either data or logic elements (e.g. an operating assistance module or a pre-processing calculation module that can be used in a predefined Node of the mesh).

Unlike most SCADA and IoT systems the CIS Smart Node software is not designed to transport only data.

It also allows the deployment of logic elements (e.g. pre-processing calculations by the HSVC module, or also an operating assistance module). These elements can be specified individually via the creation of services whose definition is transmitted to the software of each smart node (CIS Smart Nodes) by messages and by using the OPSY and REPOSI modules as well as the CNFG module.

These messages are dynamically taken into account by the service subsystems (OPSY, REPOSI and CNFG) in charge of activating the new elements. This architecture therefore allows remote configuration of the acquisition infrastructure.

In the context of an industrial process operating trial, these abilities will make it possible in particular to adapt quickly to changes in instrumentation and processing modules required for technical changes in the process or those related to the existing plant process.

They will also make it possible to distribute the operating assistance modules resulting from the data analysis carried out at the central level of a cloud.

The required input/output data produced by the processing services of a Smart Node are stored locally and also transmitted as time series or data files.

These data are transported by the mesh of smart nodes and made available to the central data analysis component (BDM). The central data analysis plafform hosts workshops and Machine Learning services to develop and train optimization and operating assistance models.

The result of executing the optimization models in the central data analysis component (e.g. flow prediction, setpoints) will produce variables and indicators. These variables can also be managed as time series by the mesh of Smart Nodes.

In particular, these variables can be transported from the central component to the plant level in order to feed the operating assistance graphical interfaces.

Communication within the mesh managed by the GCOM subsystem at each node level, may also eventually allow the GUIF subsystem to deploy local web visualization modules from the central platform to a given workshop of the process associated with a node identified in the message. It will therefore be possible for a mobile technician (equipped with a tablet or a smartphone) to access services (e.g. operating assistance) with the same level of supervision as when present in a control room.

In some embodiments, the systematic broadcast of data or commands is done by configuring the broadcast module of the node that is part of the CNFG node configuration subsystem. This broadcast module being initially configured to broadcast by messages, a variable or a given group of variables with a certain resolution and up to a certain “depth in the mesh”, for example 3 or 4 neighborhood levels.

In some embodiments, an additional functionality is first implemented as a module recognized by the node manager (OPSY) which will therefore be able to manage its lifecycle, a given node being configured to work with a certain panel of software modules under the supervision and control of the node deployment manager, this manager (OPSY) being in charge of restarts and security updates of a module that would fail or die, updates and application maintenance.

In some embodiments, each smart node, for example (N15C) for a distributed network comprises middleware (GCOM) incorporating a communication agent allowing bidirectional communications (11) with other nodes (N13C, N14C, N8B, N3A, N1A) or, preferably, towards a central platform (10) and via the neighboring node (N8B), to the neighboring nodes (N6B, N7B, N11C, N12C) communicating with the cloud (12) as required. This middleware (GCOM) combined with the OPSY functional subsystem thus allows the deployment of a plurality of nodes in a distributed mesh network (8) by the neighborhood effect.

In one embodiment, each node comprises a hardware and software arrangement, for memorizing and managing at least one object, ensuring that the status of the object is maintained at each instant known as “actual status” (as opposed to “targeted status”, wished for status) and implementing at least one method for monitoring changes in the status of the object. This method uses a memorized list of the neighborhoods of the nodes to which the node is itself connected, to inform, by using this list, each neighboring node of the possible change of status of the object.

In some embodiments, each node informs each node of its neighborhood and then the neighboring nodes inform the other nodes following a path oriented according to the specific topology of the mesh and if necessary to the central platform (10) or to the cloud (12) or to the industrial processes, each node thus informing the rest of the mesh and each node thus memorizing the object, its current status and the parent node to which the object is assigned.

The deployment of the nodes in the mesh is typically done in the following way: the software of each node is configured in the plant with a minimal range of functionalities allowing it to start up and communicate in its immediate neighborhood. These basic functions allow a first peer-to-peer broadcast of the node's features, i.e. its identifier and the configured objects. Object is understood to mean any representation of business or technical data defining a variable and/or a service.

In one variant, if a local graphical interface is embedded in each node, it makes it possible, then, to work on the most easily accessible node while allowing the configuration and the modification of the services and functionalities of a remote smart node.

The most common modifications are:
The addition of additional objects
The modification of the data broadcast policy.
The activation and/or implementation of an additional software module (for example: the ability for the smart node to become a web server, the ability to interoperate with a new system, etc.). An additional functionality is first implemented in the form of a module recognized by the Node Manager, which will therefore be able to manage its lifecycle. A given Smart Node is therefore configured to work with a certain panel of modules under the supervision and the control of the Node Manager. If a module fails or dies, the Node Manager is responsible for restarting the module and providing security updates.

Another innovative factor is that it is not at all necessary for the Smart Node on which a user is working to be the one they want to modify or to be on the same network or to have “direct IP visibility”, as would be the case of a client with a conventional server. Indeed, communication within the mesh is based on peer-to-peer communication. For example and without limitation, a modification is made locally on a node A intended for a node C. Node A shares the same neighborhood (V_{A,B}) as node B which has the neighborhood (V_{B,A}; V_{B,C;}). Node B shares the same neighborhood as nodes C. Node B is informed of the modification made to node A for the attention of C. As this one does not concern it, it simply informs its neighborhood, i.e. C. Thus, from peer to peer, the modification request arrives in the concerned neighborhood and in the concerned Smart Node (EC). Node C performs the change and if it succeeds, it informs its neighborhood that its configuration has changed. The notification of the success of the modification is thus propagated back to the rest of the mesh.

In some embodiments, the nodes are iso-functional, each node receiving an execution order coming from a program of another node of the mesh, the execution orders being either identical, or different from one node to another. Said program also associates, with the communication module of each node a node-specific identifier and a neighborhood identifier. The communication module having its node identifier and the neighborhood identifier sends messages or queries to all the connections it has had by wired or wireless means. For example, and without limitation, if the query concerns the results of a measurement, it is sent to all the nodes in the neighborhood. If among the nodes in the neighborhood there is at least one in the immediate neighborhood of the transmitting node that has the results in memory, the latter are transferred to the node concerned. If the nodes in the neighborhood are unable to respond to the request, the request is transferred to the nodes in their respective neighborhood until the node that performed the measurements responds. If no node has performed measurements, the request is transmitted to the node in the neighborhood of the sensor in charge of performing the measurements. Once the latter have been carried out, the results are transmitted from neighborhood to neighborhood as far as the node transmitting the request.

In some embodiments, the nodes have high memory capacity, each node ensuring a systematic historization operating mode provided by its own configuration, but also storage capacity reserved for episodic or opportunistic actions. Each node thus has the ability to behave quite autonomously (almost like a human being) for the historization of the data deemed appropriate.

The GCOM middleware will need to be able to provide mesh deployment of the nodes on separate and heterogeneous networks using the ITOP subsystem, without the need to build a Virtual Private Network (VPN). Indeed, the deployments may involve a multitude of different sites and entities. The establishment of a VPN would induce latencies and costs that are far too high.
The middleware (GCOM) will also, using the OPSY subsystem, need to implement security functions (security patches) to ensure the confidentiality and integrity of the data exchanged between the nodes on the one hand and also with the Big Data Management component.
The middleware (GCOM) will need to ensure secure, high-performance bidirectional exchanges with the Big Data platform also using the subsystem (USRM) for managing users and associated permissions. It will first need to support the exchange of data and then the distribution of pre-calculation services to be executed as close to the field as possible, or even instances of prediction service implementation (Machine Learning) previously trained on a central Big Data Management platform (10).

In the context of an industrial controller these abilities will make it possible in particular to adapt quickly to changes in instrumentation and processing modules required for the new technologies of the controller or those related to the existing plant process.

They will also make it possible to distribute the operating assistance modules resulting from the data analysis at a central level.

The required input/output data produced by the processing services of a Smart Node are stored locally and also transmitted as time series or data files.

These data are transported by the mesh of Smart Nodes and made available to the central data analysis component (BDM). The central data analysis platform hosts workshops and Machine Learning services to develop and train optimization and operating assistance models.

The result of executing the optimization models (e.g. flow prediction, setpoints) will produce variables and indicators. These variables can also be managed as time series by the mesh of Smart Nodes.

These variables can be transported from the central component to the plant level in order to feed the operating assistance graphical interfaces.

Communication within the mesh may also eventually allow the deployment of local web visualization modules from the central platform to a given process workshop. It will therefore be possible for a mobile technician (equipped with a tablet or a smartphone) to access services (e.g. operating assistance) with the same level of supervision as when present in a control room.

Thus, in accordance with some embodiments, the proposed network is based on a mesh of smart nodes, adaptable according to the level of aggregation between the cloud and the industrial or service sites and using messages for transmitting data or new logic elements to be deployed.

The solution therefore differs in the adaptability of the network by allowing the addition of nodes at any time by the configuration subsystem, by transmitting both data and logic elements in the messages transmitted from neighborhood to neighborhoods, by introducing modifications to the software elements and by adapting the subsystems of the nodes with the functionalities necessary for their level of aggregation in the path between the industrial or service sites and the clouds providing the data enhancement service. This solution also allows the modification of the neighborhoods of the nodes in order to modify the mesh.

The implementation of the functional layers of this global information system is therefore carried out at different levels of aggregation, so it is not just a conventional central system but an infrastructure capable of addressing highly distributed problems (sensors in the natural environment, moving vehicles or people, plants on different sites, interoperability with third-party regional systems or central systems) and highly dynamic (deployment of new services, scaling, adaptability to the availability or otherwise of parameters necessary for hyper-vision or process control optimization) problem.

The present application describes various technical features and advantages with reference to the figures and/or various embodiments. A person skilled in the art will understand that the technical features of a given embodiment may in fact be combined with features of another embodiment unless the opposite is explicitly mentioned or it is not obvious that these features are incompatible or that the combination does not provide a solution to at least one of the technical problems mentioned in the present application. In addition, the technical features described in a given embodiment may be isolated from the other features of this mode unless the opposite is explicitly stated.

It should be obvious for a person skilled in the art that the present invention allows embodiments in many other specific forms without departing from the scope of the invention as claimed. Therefore, the present embodiments should be considered to be provided for purposes of illustration, but may be modified within the range defined by the scope of the attached claims, and the invention should not be limited to the details provided above.

It will be readily apparent from the present application that the components of the present invention, as generally described and illustrated in the figures, can be arranged and designed in a wide variety of different configurations. Thus, the description of the present invention and the figures relating thereto are not intended to limit the scope of the invention but merely represent selected embodiments.

A plurality of the functional units described in this description have been named “modules”, in order to underline their independence of execution. For example, a module can be implemented by electronic circuitry, such as an integrated circuit for example, or by other types of component arrangement, such as semiconductors, logic gates, transistors or other discrete components. Such modules may also be implemented by one or more software application(s) or portion(s) of executable code within at least one software environment, for execution by various types of processors, regardless of the language used. An identified module may, for example, comprise one or more physical or logical blocks of machine instructions which may, for example, be organized as an object, process, or function. In addition, the routines and instructions of an identified module need not be physically located together, but may contain disparate instructions stored in different locations which, when functionally and logically combined together, form the module and achieve the stated purpose of the module.

Indeed, a module can be a single instruction of executable code, or a plurality of instructions, and can even be distributed among several different segments of code or among different programs and stored in a plurality of memory blocks. Similarly, operational data can be identified and illustrated in modules, and can be incorporated in any appropriate form and organized in any appropriate type of data structure. Operational data may be collected or may be distributed over different locations including different finite storage devices, and may exist, at least partially, simply as electronic signals on a system or network. In addition, the term system here means any type of terminal or device arranged to perform the functions described with reference to the modules. The system comprises data processing means making it possible to perform these described functions and may therefore comprise specific circuits performing these functions or comprise, in general, computer resources making it possible to execute the instructions described above.

References in the present description to an implementation, embodiment or alternative embodiment indicate that a device, or a module, or a structure, or a particular feature described is included in at least one embodiment of the present invention and that the various examples do not necessarily relate to the same embodiment.

In addition, the devices, structures, or features described may be combined in any appropriate way in one or more embodiments, unless they are incompatible with one another. In the present description, many specific details are provided for illustrative purposes only and have no limiting effect, so as to give precise details of the invention. However, a person skilled in the art will understand that the invention may be carried out without one or more of these specific details or with variants. On other occasions, certain aspects are not detailed so as to avoid obscuring and making the present description more complex and cumbersome and a person skilled in the art will understand that diverse and varied means may be used and that the invention is not limited only to the examples described.

The present application describes various technical features and advantages with reference to the figures and/or various embodiments. A person skilled in the art will understand that the technical features of a given embodiment may in fact be combined with features of another embodiment unless the opposite is explicitly mentioned or it is not obvious that these features are incompatible or that the combination does not provide a solution to at least one of the technical problems mentioned in the present application. In addition, the technical features described in a given embodiment may be isolated from the other features of this mode unless the opposite is explicitly stated.

It should be obvious for a person skilled in the art that the present invention allows embodiments in many other specific forms without departing from the scope of the invention as claimed. Therefore, the present embodiments should be considered to be provided for purposes of illustration, but may be modified in the field defined by the protection sought, and the invention should not be limited to the details provided above.

Having described and illustrated the principles of the invention with reference to various embodiments, it shall be recognized that the various embodiments may be modified in terms of arrangement and detail without departing from these principles. It will be understood that the various concepts and aspects of the invention described above can be implemented, for example, by using one or more processors, modules, machine-executable instructions, computers and/or servers. It should be understood that the concepts and aspects of the invention described herein are not related or limited to a particular type of computer environment, unless otherwise specified. Different types of specialized computer environments can be used to perform operations in accordance with the teachings described herein. The elements of the embodiments shown in the software can be implemented in the hardware and vice versa.

One or more devices, processors or processing devices may be configured to perform the one or more functions of each of the elements and modules of the structural arrangement described herein. For example, the one or more devices, processors or processing devices may be configured to execute one or more sequences of one or more machine-executable instructions contained in a main memory in order to implement the one or more processes or the one or more functions described herein. The execution of sequences of instructions contained in a main memory causes the processors to execute at least some of the steps of the process or functions of the elements described herein. One or more processors in a multi-processing arrangement may also be used to execute the sequences of instructions contained in a main memory or a memory readable computer. In alternative embodiments, wired circuits can be used instead of or in combination with software instructions. Thus, the embodiments are not limited to any specific combination of hardware and software circuits. The term “computer-readable medium”, as used herein, refers to any medium that is involved in providing instructions to a processor for execution. Such a medium is non-transient and may take many forms, including, but not limited to, a non-volatile medium, a volatile medium and a transmission medium. Non-volatile media include, for example, optical or magnetic disks. Volatile media include dynamic memory. Transmission media include coaxial cables, copper wire and optical fibers. Common forms of computer-readable media include, for example, floppy disks, flexible disks, hard disks, magnetic tapes, any other magnetic media, CD-ROMs, DVDs, any other optical media, punch cards, other physical media with hole patterns, RAM, PROM and EPROM, FLASH-EPROM, any other memory chip or cartridge, a carrier wave as described below, or any other medium that can be read by a computer. Various forms of computer-readable media may be involved in transporting one or more sequences of one or more instructions to the processor for execution.

Computer programs comprising machine-executable instructions for implementing at least one of the steps of the processes and/or aspects and/or concepts of the invention described herein or one or more functions of various elements of the structural arrangement described herein may be implemented or a plurality of computers comprising at least one interface, a physical processor and a non-transient memory (also generally referred to as a non-transient machine-readable storage or readable medium). The computer is a special-purpose computer because it is programmed to perform specific steps of the one or more processes described above. The non-transient memory is coded or programmed with specific code instructions for the implementation of the one or more processes above and its associated steps. The non-transient memory may be arranged in communication with the physical processor so that the physical processor, during use, reads and executes the specific code instructions embedded in the non-transient memory. The interface of the special-purpose computer can be arranged in communication with the physical processor and receive input parameters that are processed by the physical processor.

A person skilled in the art will understand that the arrangements and processes described herein represent a solution to the technological problem described above.

### DEFINITIONS OF ACRONYMS AND ABBREVIATIONS

BDM: Big Data Management
CIS: Cloud Industrial Supervision
FDR: Factory Data Repository
HMI: Human-Machine Interface
MBE: Modbus Ethernet
NIC: Network Interface Card
SCADA: Supervisory, Control And Data Acquisition
SBS: CIS Smart Node Subsystem
SNM: Smart Node Mesh
SRS: Software Requirements Specification
VM: Virtual Machine
M2M: Machine to Machine
RTU: Real Time Unit

### LIST OF REFERENCE SIGNS

(1)
(2)
(3)
(4)
(5)
(6)

1. A network of smart Nodes for a mesh distributed network (R) adaptable to industrial applications, each node (NiA, NiB, . . . , NiC) allowing, by means of GCOM communication middleware, peer-to-peer bidirectional communication with other nodes or with a central platform for Big Data Management allowing the acquisition, management and memorizing of a data lake or with a public or private Cloud, each node comprising a computer hardware architecture, said architecture running under an operating system and a software stack using an object-oriented language, the network being characterized in that one or more nodes are deployed at different aggregation levels including at least one (N5A, N10B, N15C) off the plant site, at least one (N2A, N8B, N13C) close to the plant's process automatons, at least one (N6B) in the control room and at least one (N7B, N12C) per cloud, the execution of said software stack on the computer hardware architecture implements a set of functionalities, internal communication within the mesh and external communication with other systems being message-oriented.

2. The network of smart Nodes adaptable to industrial applications according to claim 1, wherein the internal communication within the mesh of CIS nodes and external communication with other systems is based on a message-oriented architecture containing either data or logic elements.

3. The network of smart Nodes adaptable to industrial applications according to claim 1, wherein the logic elements can be specified individually through the creation of services whose definition is transmitted to the software of each smart node (CIS Smart Nodes) by messages and by using the OPSY module for managing deployments and the REPOSI module for managing software repositories as well as the CNFG module for managing the configuration.

4. The network of smart Nodes adaptable to industrial applications according to claim 1, wherein each node of the network comprises a plurality of functional subsystems suitable for aggregating the node into the network.

5. The network of smart Nodes according to claim 1, wherein the functional subsystems are selected for all the nodes among the following modules:
CNFG for managing the configuration of each smart node;
OPSY for managing software deployments (e.g. for security patches, upgrades and application maintenance);
REPOSI for managing software repositories;
ITOP for managing interoperability with third-party systems;
GCOM for managing communication within the mesh (middleware); or
USRM for managing users and permissions.

6. The network of smart Nodes according to claim 1, wherein the functional subsystems of a node placed in the neighborhood of the process automatons of a plant comprise: the LSVC subsystem for the functionality of managing drivers and technical services for industrial instrumentation.

7. The network of smart Nodes according to claim 1, wherein the GUIF functional subsystems of a node deployed from the central platform makes it possible to produce web visualization modules local to a given workshop of the process defined by the node close to the workshop identified in the message.

8. The network of smart Nodes according to claim 1, wherein the functional subsystems of at least one intermediate node between the node neighboring the automatons and the node neighboring the cloud comprise the module is made up of HSVC for managing pre-processing and local calculations on the results or plant data.

9. The network of smart Nodes according to claim 1, wherein the functional subsystems of at least one node exchanging with nodes in other countries comprise the UTLY module for managing utilities such as multilingual management.

10. The network of smart Nodes according to claim 1, comprising at least one of the following functionalities:
creation and management, for itself or the other nodes of the mesh, of objects adapted to industrial processes in order to supervise and control all types of processes, the set of objects defined for the entire mesh and known by each node being referred to as “object dictionary”;
deployment of a plurality of nodes in a distributed mesh by the neighborhood effect;
start-up and communication of each node via the communication module, in its immediate neighborhood thanks to a plant configuration with a minimal range of functionalities;
memorizing and management of at least one object by each node to maintain the current status of the object and using a memorized list of neighborhoods of the nodes to which it is itself connected, in order to inform each neighboring node of any change in the status of the object;
association, with the communication module of each node, of a node-specific identifier and a neighborhood identifier, in order to make each node iso-functional and capable of receiving an execution order coming from a program of another node of the mesh.

11. The network of smart Nodes according to claim 1, wherein the systematic broadcast of data or commands is done by configuring the broadcast module of the node, this broadcast module being initially configured to implement, by execution on the computer hardware architecture, a functionality for broadcasting, within the network (8), a variable or a given group of variables with a given resolution and up to a given depth in the mesh, for example 3 or 4 neighborhood levels.

12. The network of smart Nodes according to claim 1, comprising a node management module that manages the functionalities implemented by the software modules, executed on the computer hardware architecture, by monitoring and controlling the restarting and security updates of a software module that would fail or die.

13. The network of smart Nodes according to claim 1, wherein each object belongs to at least one class which is a description of the features of one or more objects representative of an industrial process or a business feature, each object being created from this class and constituting an instance of the class in question, the features and the status of an object being manipulated by methods incorporated in the smart node, the status of an object corresponding to the information stored at a given time, as described by the values of all its properties, also called fields or attributes.

14. The network of smart Nodes according to claim 1, wherein each node comprises at least one software layer, said software layer implementing, by execution on the computer hardware architecture, a functionality for memorizing, in addition to the information coming from the process sensors, an attribute indicating that the node concerned is a parent of the object referred to as “parent node”.

15. The network of smart Nodes according to claim 1, wherein each node comprises a device comprising at least one software layer, said software layer implementing, by execution on the computer hardware architecture, a functionality for informing each node of its neighborhood so that the neighbor nodes inform the other nodes following a path oriented in a direction which depends on the specific topology or architecture of the mesh, defining the links between the nodes of the network, and if necessary following a path oriented towards a central platform (10) or towards the processes, each node thus informing the rest of the mesh and each node (1) thus memorizing the object, its current status and the parent node to which the object is assigned.

16. The network of smart Nodes according to claim 1, wherein said functionalities implemented by the node also comprise the broadcast, in the form of time series, of the data collected or calculated by each node, said broadcast being carried out by using at least one of the following two data broadcast modes: a so-called systematic broadcast mode wherein the data are broadcast with a given resolution and up to a given depth in the mesh, and a so-called opportunistic broadcast mode wherein at least one node neighboring another node concerned by a given initial request autonomously records the information or data which passes through it in its memory in order to rebroadcast said data or information when a request similar to the initial request is made again, the pattern or scheme for broadcasting data broadcast by the nodes differing from a systematic replication scheme wherein the data broadcast scheme is duplicated identically for all the nodes.

17. The network of smart Nodes according to claim 1, wherein each node is configured to implement a planned functionality for the systematic historization of data, but also the storage of the actions that take place periodically or actions relating to the so-called opportunistic broadcast mode in its memory, each node thus having the ability to behave autonomously for the historization of the data collected during actions that take place periodically or actions relating to the so-called opportunistic broadcast mode.

18. The network of smart Nodes according to claim 1, wherein each node of the mesh or a central platform comprises a device including at least one software layer, said software layer implementing, by execution on the computer hardware architecture, the functionalities for creating and managing, for itself or the other nodes of the mesh, objects adapted to industrial processes so as to control all types of processes, the group of objects defined for the entire mesh and known to each of the nodes being referred to as “object dictionary”.

19. The network of smart Nodes according to claim 1, wherein each node has at least one interface for accessing an image of the “object dictionary”, this interface being configured to define a new node or a new object for a node, the modification request being broadcast in the mesh and transmitted from one node to another to the parent node concerned if the modification made to the dictionary does not concern the node from which the manager is accessed, the parent node of the object then executing the request, the result of the execution then being broadcast in turn to the rest of the mesh, each node receiving this result then updating its own image of the “object dictionary”.

20. The network of smart Nodes according to claim 1, wherein said functionalities implemented by each smart node comprise rebroadcasting, via its broadcast module, to the rest of the mesh and at configurable time intervals, the status of its own objects, in order to compensate for any temporary or persistent communication breakdown in the mesh, this ability enabling the mesh to restore, if necessary, the integrity of the various images, associated with the various nodes of the mesh, of the “object dictionary”.

21. The network of smart Nodes according to claim 1, wherein the objects are manipulated without the modifications made to the status of one object calling upon or influencing the status of another object, each object having access authorization for any use or any entity in the industrial process, with the attributes or definition fields of the objects being changed dynamically by the node manager.

22. The network of smart Nodes according to claim 1, wherein each object uses a method that defines a quality parameter associated with same, said quality parameter representing the deviation between a desired target value of the status of an object and the actual status of the value.

23. The network of smart Nodes according to claim 1, wherein each node of the mesh or the central platform comprises a device comprising at least one software layer, said software layer implementing, by execution on a computer hardware architecture, a functionality for connecting to any node of the mesh, by sending the identifier of the node to be modified, so as to remotely and dynamically modify the node concerned even if the user is connected to a node that is not the parent node of the object to be modified.
